(19) United States
(12) Patent Application Publication
(10) Pub. No.: US 2004/0191919 A1
(43) Pub. Date: Sep. 30, 2004

(54) METHOD AND DEVICE FOR ANALYSIS OF A MEDICAL FLUID

(75) Inventors: Peter Unger, Stockholm (SE); Birgitta Ekman Sparrman, Stockholm (SE)

Correspondence Address: GAMBRO, INC, PATENT DEPARTMENT, 10810 W COLLINS AVE, LAKEWOOD, CO, 80215, US

(73) Assignee: GAMBRO, INC., Lakewood, CO (US)

(21) Appl. No.: 10/708,989

(22) Filed: Apr. 6, 2004

(30) Foreign Application Priority Data
Oct. 7, 2002 (WO) PCT/SE02/01824
Oct. 6, 2001 (SE) 0103340-6

(51) Int. Cl. G01N 21/00

(52) U.S. Cl. 436/164; 436/165

(57) ABSTRACT

A method and a device for analyzing a medical fluid in a closed bag set. The bag set has an analysis device connected to integrally connected to a bag containing the medical fluid via a connection tube. The analysis device has an expandable air pocket having a reagent on an interior surface. When the medical fluid is to be tested, the air pocket is expanded and the medical fluid flows through the connection tube and into the air pocket and contacts the reagent material. The connection tube may have a valve or frangible pin or membrane preventing the medical fluid from entering the connection tube until the test procedure is started. A reaction of the reagent to the medical fluid may be detected by an optical apparatus such as a CCD or CMOS optical sensor. The air pocket may be enclosed by a cassette for exerting an under-pressure at the outer surfaces of the air pocket in order to draw medical fluid into the analysis device.

### CROSS REFERENCE TO RELATED APPLICATIONS

This application claims the benefit of International Application PCT/SE02/0182, filed Oct. 7, 2002, which claims the benefit of Swedish Application 0103340-6, filed Oct. 6, 2001.

### BACKGROUND OF INVENTION

The invention relates to a method and a device for analysis of a medical fluid, for example an infusion solution or biological material, in order to determine important parameters such as sterility, pH, or presence of non-adequate cells in a cell suspension comprising red blood cells or blood platelets. This is an important analysis measure before infusion of a medicine or transfusion of a blood suspension to a patient.

A previously known method for direct detection of bacteria in a cellular blood product is disclosed in the article “Direct detection of bacteria in cellular blood products using bacterial ribosomal RNA-directed probes coupled to electrochemiluminescence” by R. Chaney, J. Rider and D. Pamphilon published 1999. The known methods are, however, relatively difficult to practice and require often that the blood product be opened, which renders the product unsterile by being exposed to air. Moreover, the methods are not fully adapted to be industrially used at every product but they are often used by taking samples.

A method and device for determining medical parameters of a urine solution is known from DE 3504527. The urine-collecting bag comprises reagent material at the interior surface, which reacts with the urine to indicate certain parameters, such as glucose, protein, pH, and infection.

Certain medical fluids need to be stored before use. Such fluids are, for example, medical agents in fluid form, infusion solutions, such as nutritional solution (comprising glucose) or Ringer's solution (physiological salt solution), dialysis solutions (in concentrated or diluted form), peritoneal dialysis solutions, etc. These medical fluids are intended for infusion in a patient in different situations and need to be sterile and non Another class of medical fluids is biological solutions, comprising biological material or cells, such as blood replacement solutions, blood component suspensions such as red blood cell suspensions, platelet suspensions, whole blood, etc.

These fluids may be stored for a number of days or months up to several years before use. It may be desired to test these fluids for contamination with bacteria or virus before use. Moreover, certain fluids may develop toxicity over time, such as glucose solutions, and such toxicity may be tested. A fluid intended for infusion should have a near neutral pH, which also may be tested.

Furthermore, the medical fluid is expected to be sterile and may not be contaminated by the test method. Thus, the test should be performed without exposing the fluid to external air, which may be contaminated.

The fluid may be filled into a bag or bag set under controlled conditions in a sterile state and the bag is closed.

If the fluid is a biological product or certain medical agents, it cannot withstand sterilization conditions. In this case, the bag set is sterilized separately and the fluid is filled into the bag set under as aseptic or sterile conditions as possible.

If the fluid is an infusion solution (hemodialysis solution or peritoneal dialysis solution), it is normally sterilized after being filled in the bag set, so that the fluid and the bag set are sterilized at the same time.

Since it is presumed that the product is sterile immediately after being filled in the bag, it is no use to practice the method disclosed in DE 3504527, since this method determines the parameters of the fluid, when the fluid is filled into the bag.

Thus, a first object of the invention is to provide a method for the analysis of the fluid after being stored and shortly before use. In this way, it can be determined if the fluid has been contaminated during storage and is no longer suitable for its medical purpose.

A second object of the invention is to provide a method and device for testing the fluid without exposing the fluid to external contamination. Thus, the test method should be independent of external parameters and it should be possible to determine if the product has been contaminated due to only storage parameters. Thus, any contamination because of connection of connectors or exposure to air may be eliminated.

A third object of the invention is to provide a method and device for testing a medical fluid which is easy and inexpensive to perform and which can be practiced on every medical fluid as a routine measure. Thus, it is no longer necessary to take samples and trust that the samples are representative for the batch of medical solutions.

### SUMMARY OF INVENTION

In order to reach the above objects, a method and a device are provided in order to analyze a medical fluid, present in a closed bag set, for example after storage. The bag set is provided with an analysis device connected to the medical fluid via a connection tube. Moreover, the analysis device comprises an expandable air pocket. The volume of the air pocket is large enough to accommodate the air present in the connection tube. The air pocket or the connection tube or both are provided with analysis means at the interior surface thereof.

When the medical fluid is to be tested, the air pocket is expanded and the medical fluid flows into the connection tube and to the analysis pocket for contact with the analysis material. If the analysis is positive, the medical fluid is used for its purpose.

The medical fluid, which has entered the connection tube and the air pocket, is left there, so that the analysis means will not contaminate the rest of the medical fluid. The medical fluid may be agitated before the test procedure so that the sample, which flows into the connection tube, is representative of the entire medical fluid.

The connection tube may be provided with a valve or frangible pin or membrane preventing the medical fluid from entering the connection tube until the test procedure is started. The air pocket and/or the analysis pocket may be arranged to be collapsed and have a tendency to expand due to material forces, thus generating an under-pressure inside the analysis device. When the frangible pin is broken, the medical fluid is positively sucked analysis device.

The analysis means may be read by the human eye in order to determine if there is a contamination, which normally result in a change of color of a reagent material of the analysis means.

Alternatively, the determination may be performed automatically by an optical apparatus. If possible contamination of a red blood cell suspension with white blood cell is to be determined, counting of white blood cells can take place automatically by means of a CCD or CMOS optical sensor and image processing as is known in the prior art.

The air pocket may be enclosed by a cassette comprising the optical analysis apparatus.

The cassette may comprise mechanical, pneumatic, or hydraulic devices for exerting an under-pressure at the outer surfaces of the air pocket in order to positively suck in medical fluid in the analysis device.

The analysis device may be connected to the medical fluid bag. Alternatively, the analysis device may be connected to an outlet tube for flowing the fluid to a patient.

The procedure may be performed before the bag set is connected to the patient, but may also be performed as a step in the connection procedure.

### BRIEF DESCRIPTION OF DRAWINGS

FIG. 1 is a plan view of a component bag provided with an analysis pocket according to the invention.

FIG. 2 are cross sectional views taken along the line 11-11 of FIG. 1.

FIG. 3 are cross sectional views taken along line 111-111 of FIG. 1.

FIG. 4 is an embodiment of an analysis device according to the present invention.

FIG. 5 is a second embodiment of an analysis device.

FIG. 6 is another embodiment of an analysis device.

FIG. 7 is a representation of cuvette for reading the analysis device of FIG. 1

FIG. 8 is a cross-sectional view through a cassette device that can be adapted around the analysis pocket according to FIG. 1.

FIG. 9 is a cross-sectional view similar to FIG. 8 and shows an optical analysis device for the analysis pocket of FIG. 1.

FIG. 10 is a cross-sectional view similar to FIG. 8 and shows another optical analysis device for the analysis pocket according to FIG. 1.

FIG. 11 is a cross-sectional view through a machine for manufacturing the analysis pockets according to the invention.

FIG. 12 is a partial longitudinal section through the machine of FIG. 11.

### DETAILED DESCRIPTION

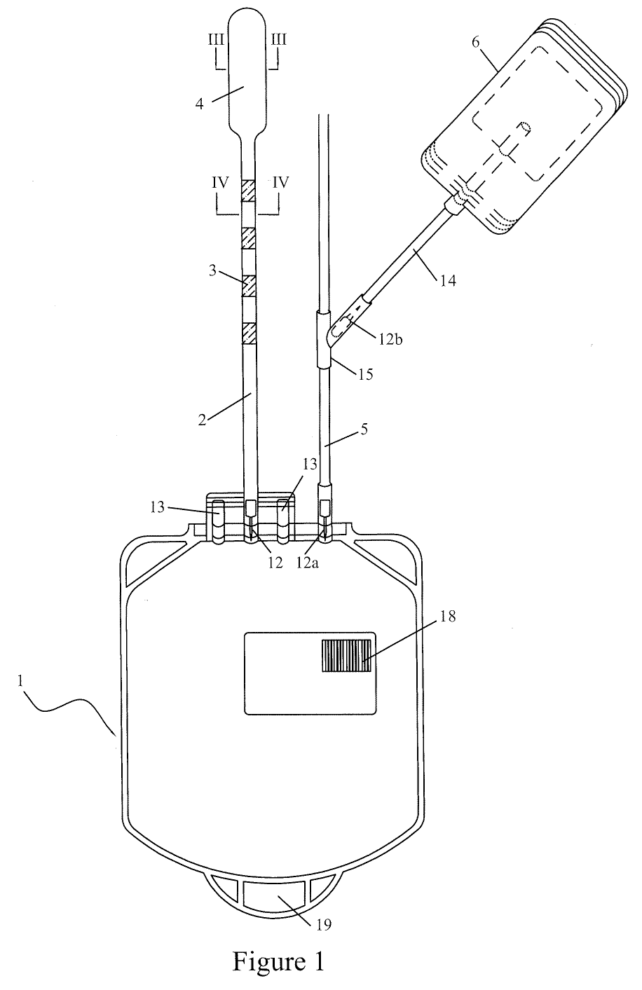

FIG. 1 discloses a fluid bag 1 enclosing a medical fluid to be stored and infused into a patient. The fluid bag 1 comprises an outlet tube 5 for connection to a patient. The outlet tube 5 may comprise a frangible pin 12a so that the medical fluid will not pass into the outlet tube 5 until just before use, when the frangible pin 12a is broken and the medical fluid is allowed to flow out via the outlet tube 5.

Furthermore, the fluid bag 1 is provided with closed openings 13 for initial introduction of the medical fluid into the bag. A label 18 is provided on the fluid bag 1 in order to inform the user about the contents thereof.

The medical fluid in the bag may be any fluid intended to be infused into or transfused to a patient or that is to be maintained sterile of any purpose. Moreover, the fluid may be a fluid that is used for treating a medical fluid to later be infused into a patient, such as a rinsing or washing solution for rejuvenating erythrocyte suspensions, or a virus inactivation agent. The medical fluid may be selected from: fluid medical agent, infusion solution, hemodialysis solution, peritoneal dialysis solution, nutritional solution, physiological saline solution, blood component solution, erythrocyte suspension, platelet suspension, etc.

An analysis device is connected to the fluid bag 1. In FIG. 1 the analysis device comprises a connection tube 2, analysis means 3 and an air pocket 4. The connection tube 2 is connected to the fluid bag 1 via a frangible pin 12.

Upon breaking of the frangible pin, fluid connection is established between the medical fluid and the connection tube 2.

The analysis means 3 are provided at the interior surface of the connection tube 2 or the air pocket 4, see below. The analysis means 3 may be any reagent material or agent that is suitable for the purpose of indicating a parameter of the medical fluid to be analyzed or tested. Such parameters may be sterility, presence of bacteria or virus, toxicity, pH, glucose, protein, presence of white blood cells in an erythrocyte suspension, etc.

The analysis means 3 may test or indicate several parameters at the same time, for example pH and bacterial contamination. In FIG. 1, four different analysis means 3 are shown at connection tube 2.

The fluid bag and the analysis device are sterilized together, either before introduction of the medical fluid via openings 13, if the fluid cannot withstand sterilization, or after the fluid has been introduced into the fluid bag.

The analysis device is used in the following manner. After storage of the medical fluid, the fluid bag 1 is removed from storage and the contents are agitated in order to mix the fluid uniformly. This may take place by squeezing the fluid bag one or several times so that the fluid mixes. The fluid bag may also be turned around several times to effect agitation and mixing. Then, the fluid bag 1 is arranged at a stand hanging in the hole 19 so that the analysis device faces downwards, i.e. opposite the direction shown in FIG. 1. Then, any air inside the fluid bag accumulates at the top close to the hole 19. The frangible pin 12 is broken in order to establish fluid connection between the medical fluid in the fluid bag 1 and the connection tube 2. Before breaking the frangible pin 12, the air pocket 4 is collapsed as shown at 4a in FIG. 3. Because of the hydrostatic pressure of the medical fluid, it starts to flow into the connection tube 2 expelling the air inside the tube into the air pocket, which expands, as shown at 4b in FIG. 3. The volume of the air pocket is sufficiently large to accommodate the air inside the tube 2. Thus, the medical fluid is free to flow into the connection tube 2 into contact with the analysis means or strips 3. Then, the analysis strips 3 change color, if the parameter to be tested is valid. The result of the test is read by the user. If the test result is positive, indicating that the medical fluid is suitable for its purpose, the frangible pin 12a in the outlet tube is broken and the medical fluid is passed to the patient.

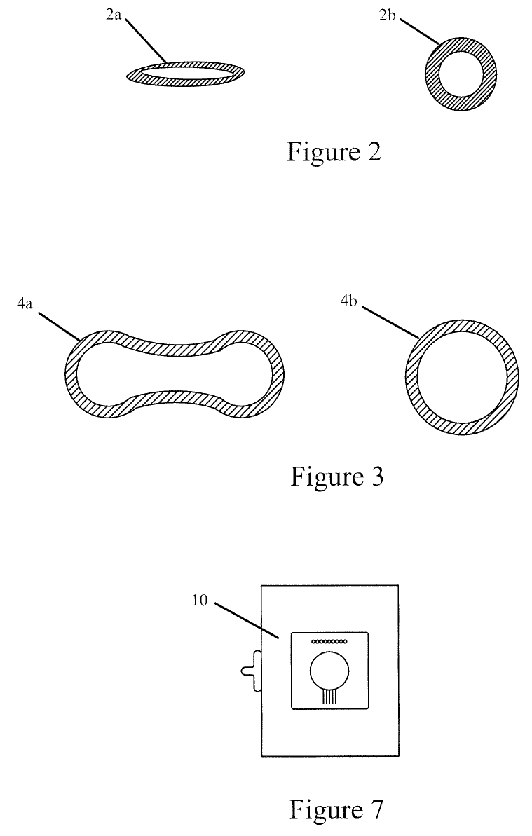

As further shown at 3a in FIG. 2, the connection tube 3 may be partially collapsed before use and may have an oval cross-section. The condition before use shown at 2a is obtained during the manufacturing of the fluid container and the analysis device by exposing the interior of the analysis device to an under-pressure before being closed.

The wall thickness of the connection tube and air pocket may be so that a certain tension is obtained striving to return the tube 2 and air pocket to the original form shown at 2b and 4b. Alternatively, the wall thickness may be small and/or the material soft, so that an external under-pressure is required to transfer the connection tube 2 and air pocket 4 from the collapsed position shown at 2a and 4a respectively to the expanded position shown at 2b and 4b. The hydrostatic pressure of the fluid may be sufficient to perform the transfer.

Another alternative is that the connection tube 3 is always circular and that the air pocket 4 initially is expanded as shown at 4b. After breaking the frangible pin, the air pocket is squeezed by finger pressure in order to expel air inside the air pocket through the connection tube 2 into the medical fluid bag 1. The expelled air bubbles up to the top of the fluid bag at the hole 19. Then, the air pocket is released, and the medical fluid can enter the connection tube, again expanding the air pocket.

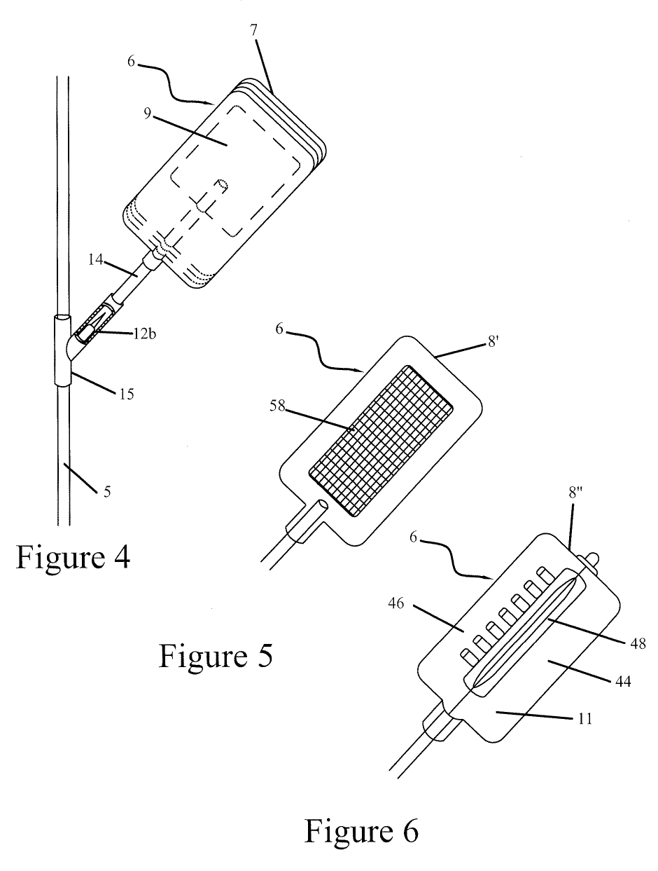

A second embodiment of the invention is also shown in FIG. 4. Therein, an analysis device 6 is arranged at an outlet tube 5, which is provided with a division piece or y-connector 15 shown in FIG. 1. The analysis device 6 is connected to the division piece 15 and includes a connection tube 14 provided with a frangible pin 12b, and an air pocket 9. The air pocket 9 is made of two plastic foils being welded together and to the connection tube 14, as further explained below. The interior surfaces of the plastic foils are coated with a reagent agent.

The operation of the second embodiment is slightly different from the first embodiment. First, the medical fluid bag 1 is taken from the storage, and agitated as explained above and arranged at the stand via hole 19. The frangible pin 12a in the outlet tube 5 is broken and the medical fluid is allowed to enter the outlet tube in order to expel the air inside it and rinse the outlet tube and further devices downstream of the division piece 15. When this procedure is ready and the outlet tube 5 is to be connected to the patient, the medical fluid is tested according to the invention, either before or after connection. The frangible pin 12b in the connection tube 14 is broken and the medical fluid is allowed to enter the connection tube 14 and the air pocket 9, thereby expanding the plastic foils. The volume between the plastic foils is sufficient to accommodate the air expelled from the connection tube 14. When the medical fluid enters the air pocket 9 into contact with the analysis material at the interior surface of the plastic foils, a reaction takes place and a change of color indicates if the fluid is contaminated or not. The color change is read by the user, and the procedure is continued if the test is positive.

The analysis device 6 and the air pocket 9 may be protected before use by a protection bag 7, which is removed shortly before use. The protection bag may be opaque in order to protect the analysis material from surrounding light, if the analysis material is sensitive to light over a long period, such as during the storage. The protection bag may protect the air pocket from the surrounding oxygen in the air, whereby the protection bag is tight for oxygen.

Reading of the color change may take place automatically. In this case, a cuvette 8′, shown in FIG. 5 is arranged surrounding the air pocket 9. The cuvette may comprise a rigid housing enclosing the air pocket. The housing comprises a light source 58 and a photo-sensor 60 as shown in more detail in FIG. 10. The photo-sensor 60 may be a two-dimensional CMS or CCD sensor. The automatic analysis may take place by a computer program. Alternatively, the photo-sensor 60 may be sensitive to certain colors only and may give a signal dependent on this color.

A cuvette 8″ may also be arranged to expose the air pocket to a negative pressure. In this case, the cuvette 8″ surrounds the air pocket in an airtight manner.

Furthermore, the cuvette 8″ may be arranged to break a frangible pin automatically upon closing the cuvette. The frangible pin may be arranged in the connection tube close to the attachment of the plastic foils. The cuvette comprises two halves 44, 46 joined by a hinge 48 as shown at 8″ in FIG. 6. When the two halves are brought towards each other and interact, they also at the same time engage the frangible pin and break it to establish fluid communication with the medical fluid.

Several analysis devices may be arranged consecutively along the outlet tube in order to test different parameters of the medical fluid. Each analysis device may test a separate parameter. Alternatively, one or several analysis devices may test two or several parameters each.

A cuvette 8′ for automatic reading of the test result of the analysis device 6 is schematically shown at 10 in FIG. 7.

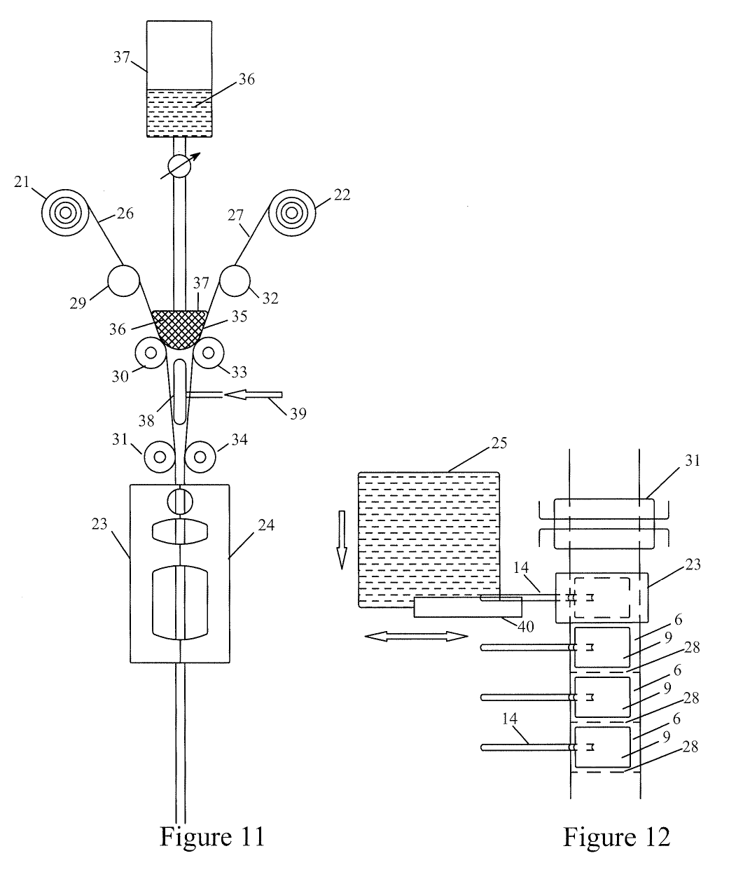

FIG. 11 discloses a cross-section through a manufacturing device for the analysis device 6 according to the invention, more specifically, the second embodiment described above. The air pocket 9 is made from two plastic foil rolls 21, 22 and the foils 26, 27 are drawn downwards by a pulling device, not shown, which is synchronized with the movement of two welding plates 23, 24 and a feeding device 40 for connecting tubes 14 from a tube magazine 25, schematically shown in FIG. 12.

The welding plates 23, 24 are shaped so that they insert the tubes 14 between the foils 26, 27 and generate a closed room around these ends with the smallest possible amount of air enclosed. Moreover, they are formed so that a tearing line 28 is formed between the air pockets 9, so that they can be separated from each other.

The tube end thus welded to the air pocket 9 has a closed end weld and a slit in the tube wall so that the tube forms a flow valve through which fluid can flow into the pocket, but cannot pass out.

The plastic foils 26, 27 are controlled by a number of support rolls 29, 30, 31, 32, 33, 34. Between the upper support roll pair 29, 32, there is a coating means 35 of reagent solution 36 with which the inner surfaces of the analysis pocket should be prepared. The reagent fluid 36 is applied from a reagent fluid bag 37 and it is dried by hot air, which is directed out between the plastic foils via a distributor 38. The hot air comes from a hot air device, not shown, as suggested by arrow 39.

FIG. 12 is a longitudinal section perpendicular to FIG. 11. At the upper part, the tube magazine 25 is shown and beside it, there is shown the lower support roll pair 31, 34.

Below these support rolls 31, 34, there is shown the welding plates 23, 24 and a feeding device 40 for feeding the tubes from the magazine in between the foils, where they are welded. Below the welding device, there are shown a number of ready-made air pockets 9.

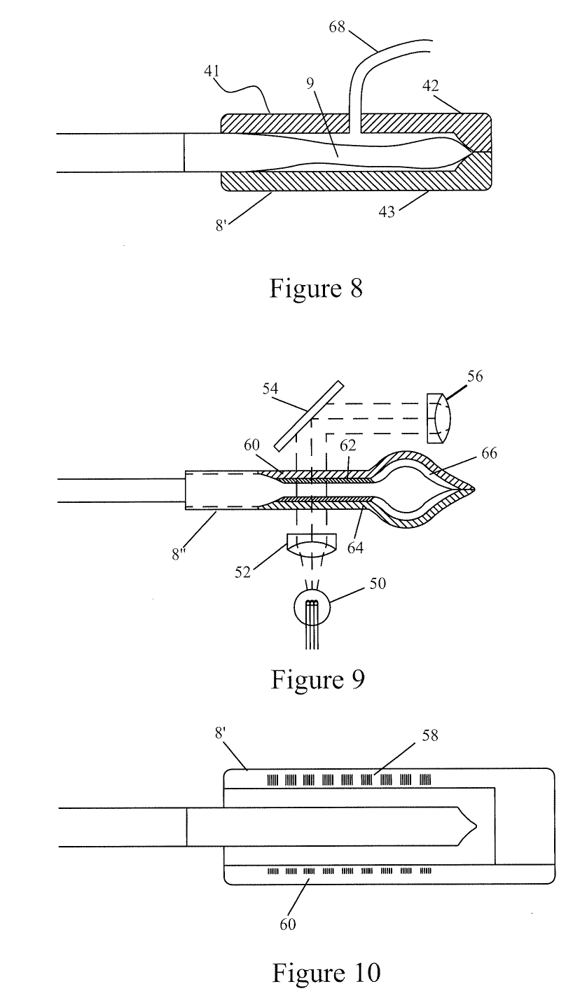

FIG. 8 shows a cassette device 8″, which surrounds the air pocket 9 when this is to be filled with a blood component that is to be analyzed. The cassette is so shaped that it can receive exactly the desired amount of blood component. The cassette comprises a double frame 42, 43 of non-foldable plastic material with soft corners which do not hurt the component bag 1 or the other bags included in the bag set, for example during the centrifugation process.

FIGS. 9 and 10 show two different optical devices for the samples. In FIG. 9, the sample is photo-optically analyzed and is projected towards, for example, a screen at which the number of particle dots per out volume can be read (enlarged counting chamber). A light source 50 and a collimator 52 direct light towards the cassette or cuvette 8, which is made of a transparent material. A mirror 54 redirects the light passing through the cuvette 8 and the sample of the medical fluid inside the air pocket. A lens 56 focuses the picture of the sample at a screen (not shown) for analysis.

In FIG. 10, the analysis method is electronically photosensitive. A light source 58 directs light through the sample and a photo-sensor 60 analyses the result. The light source may be several light emitting diodes or an extended continuous light source as used in LCD displays in the computer industry. The photo-sensor 60 may be a CCD or CMS sensor, which is connected to an image processing circuitry for analysis.

A frangible pin 12b has been disclosed as closing the connection tube from the medical fluid in the fluid bag before use. Since the fluid may be stored for a long time, there is the risk that the analysis agent will deteriorate if it is exposed to a humid atmosphere. However, the frangible pin may be replaced by another means performing the same function, such as a valve manually operated by the user. Another alternative device may be a rupturable membrane arranged in the connection tube. When the membrane is exposed to a high pressure, for example by squeezing the air pocket 4 of FIG. 1, it ruptures and opens the connection to the medical fluid. The same effect may be obtained in the second embodiment by exerting a high positive pressure by the cuvette 8.

In certain embodiments, the operation of the valve may be replaced by folding the connection tube 2 over 180 degrees and storing it in this position. When the analysis device is to be used, the connection tube is unfolded. If required, a positive pressure is applied by squeezing the air pocket in order to open the fluid flow path beyond the fold position of the tube.

As further shown in FIG. 9, the cuvette 8 or cassette may comprise a first portion 60 close to the connection tube and having parallel flat surfaces 62, 64 with a short distance between the surfaces, so that the air pocket forms an analysis portion having well defined dimensions. The distance between the surfaces may be 0.5 mm. The rest of the cuvette forms a space 66 sufficiently large to accommodate the air pocket portion filled with air.

As shown in FIG. 8, the cuvette or cassette may comprise a tube 68 connected to a source of under-pressure, in order to generate the under-pressure mentioned above for sucking in the medical fluid into the connection tube and air pocket.

The invention has been described above with reference to embodiments of the invention, but is not limited to the embodiments described but is limited only by the appended patent claims.

1. A method for analysis of a medical fluid, comprising the steps of
providing a fluid bag for containing a medical fluid, said bag being integrally connected to an analysis device through a connection tube, said analysis device containing a reagent capable of reacting with a component in said medical fluid and said analysis device having an air pocket to draw the medical fluid present in the fluid bag into the analysis device,
expanding the air pocket, and
flowing the fluid into the connection tube and into contact with the reagent in the analysis device.

2. The method according to claim 1, further comprising opening fluid communication from said fluid bag to said analysis device.

3. The method according to claim 2 wherein said step of opening fluid communication comprises breaking a frangible pin. or membrane, or by opening a valve.

4. The method according to claim 2 wherein said step of opening fluid communication comprises breaking a membrane.

5. The method according to claim 2 wherein said step of opening fluid communication comprises opening a valve.

6. The method according to claim 2, further comprising arranging a cassette surrounding the air pocket, exerting a negative pressure inside the cassette in order to generate an under-pressure in the air pocket, and flowing the medical fluid into the analysis device.

7. The method according to claim 1, further comprising displaying a reaction of the reagent.

8. The method according to claim 7, further comprising reading the reaction of the reagent by an optical analysis apparatus arranged at the cassette means.

9. A device for analysis of a medical fluid, comprising
a fluid bag,
a connection tube having one end integral with the fluid bag;
an air pocket integrally connected at a second end of the connection tube; and
analysis means within said air pocket and in fluid communication with said connection tube, said analysis means comprising a reagent material capable of reacting with components in said fluid.

10. The device according to claim 9, further comprising a blocking device arranged in the connection tube.

11. The device according to claim 10 wherein the blocking device is a frangible pin.

12. The device according to claim 10 wherein the blocking device is a membrane.

13. The device according to claim 10 wherein the blocking device is a valve.

14. The device according to claim 9, further comprising a cassette surrounding the air pocket.

15. The device according to claim 9, further comprising an optical device for detecting the reaction of the analysis means.

16. The device according to claim 9, wherein the air pocket comprises two connected plastic foils, and said reagent material is coated on an inner surface of at least one of said foils.

17. The device according to claim 16, wherein the air pocket is expandable and has a maximum volume larger than the volume of the air enclosed in the connection tube.
